(19) United States
(12) Patent Application Publication
(10) Pub. No.: US 2016/0004058 A1
(43) Pub. Date: Jan. 7, 2016

(54) LIGHTSHEET MICROSCOPY WITH ROTATIONAL-SHEAR INTERFEROMETRY

(71) Applicant: Leonard Rodenhausen WAYNE, (US)

(72) Inventor: Leonard Rodenhausen Wayne, Washington, DC (US)

(21) Appl. No.: 14/768,792

(22) PCT Filed: Mar. 11, 2014
(86) PCT No.: PCT/US2014/023534

§ 371 Date: Aug. 19, 2015

Related U.S. Application Data
(60) Provisional application No. 61/801,913, filed on Mar. 15, 2013.

(51) Int. Cl. G02B 21/00; G02B 21/36; G01B 9/02

(52) U.S. Cl. CPC G02B 21/0056; G01B 9/0203; G02B 21/0032; G02B 21/367; G02B 21/006

(57) ABSTRACT

Devices and methods for lightsheet microscopy using rotational-shear interferometry are provided. Advantages include improved lateral spatial resolution and easier alignment.

### FIELD OF THE INVENTION

The present invention relates generally to lightsheet microscopy, and more particularly but not exclusively to rotational-shear-interferometer lightsheet microscopes.

### BACKGROUND OF THE INVENTION

### Lightsheet Microscopy

Lightsheet microscopy is a technique for imaging a sample in all three spatial dimensions (“3-D”), in which a “sheet” of light illuminates one slice at a time of the sample under study. This is illustrated in FIG. 1. (Lightsheet microscopy is sometimes also referred to as “selective plane illumination microscopy.”) A “detection microscope” records a two-dimensional (“2-D”) image of the region illuminated by the lightsheet. The lightsheet may be scanned step-by-step through the sample, or the sample may be scanned step-by-step through the lightsheet. A 2-D image is recorded at each step. Eventually the entire object may be illuminated and imaged, and the 2-D images fused together with software to make a 3-D image of the sample.

The 3-D imaging of fluorescent labels in a biological specimen is an example of a common application of lightsheet microscopy. The illumination light may serve to activate the fluorophores which fluoresce in response. The detection microscope may then capture the light emitted by the fluorophores and form a 2-D image of the locations of the fluorescent labels in response to the illumination by the lightsheet. As the lightsheet and/or sample is scanned, a 2-D image is captured at each scan step. A 3-D image may be assembled from the 2-D images, showing the distribution of fluorescent labels within the specimen.

Many current lightsheet microscopes suffer from at least one of the following difficulties.

### Exemplary Difficulty #1—Exacting Alignment

A lightsheet microscope requires alignment between (1) the location of the lightsheet and (2) the region-of-focus of the detection microscope. This alignment requirement is illustrated in FIGS. 2 and 3. The alignment is required largely for system focus. Without the alignment the 2-D images recorded by the detection microscope will be blurred, and blurring is undesirable.

With many current lightsheet microscopes this alignment is exacting. Significant effort and cost are needed to meet the alignment requirement. The “z-offset” and the “tilt-offset” both need to be minimized to a value that is exacting to achieve. As used herein the terms “z-alignment” and the “tilt-alignment” refer to the alignment of such offsets, as defined below under “Definitions.” The exacting nature of these alignments has negative impacts at each stage in the life of the lightsheet microscope. The need for exacting z-alignment and tilt-alignment can complicate the design, manufacture, and/or use of many current lightsheet microscopes.

For example, the choice of construction materials is constrained to materials able to maintain shape and dimension against even small thermal and mechanical disturbances. These constraints impede the system design. Further, the system designer may be pushed harder to make tradeoffs against other system parameters and thus reduce overall system performance. For example, these constraints may push the system designer to decrease the numerical aperture of the detection microscope in order to increase the depth-of-field of the detection microscope and thus allow for easier system alignment. A decrease in the numerical aperture of a microscope degrades the lateral spatial resolution of the microscope, which is undesirable. Further, exacting alignment requirements may force the system designer to incorporate alignment mechanisms (tip/tilt controls, etc.) with a finer adjustment capability. This complexity may increase system cost and may impede the system designer.

Furthermore, the exacting alignment requirements make system manufacture more difficult and more expensive. More effort may be required to achieve the alignment requirements. And greater cost may be required since the construction material choices are constrained and since more system complexity may be required.

Even after the system is manufactured, the exacting alignment requirements may negatively impact the use of the system in the field. The user generally may need to perform a final alignment of the system in the moments before each measurement is performed. More effort may be required if the alignment is more exacting. Related to this is a difficulty with many current lightsheet microscopes described by Huisken in U.S. patent application publication 2011/0115895, the entire contents of which application are incorporated herein by reference: typically, “the [lightsheet] is aligned before the experiment to illuminate the focal plane of the detection lens. This alignment is not changed for individual samples. However, samples differ tremendously in their optical properties. Refraction at the medium-sample interface will divert the [lightsheet] away from the focal plane and result in a blurry image.” This reduces the variety of samples that can be imaged without re-alignment. Furthermore, alignment generally must be maintained throughout the duration of the measurement. The exacting nature of the alignment requirements may make this more difficult. The difficulty is more acute for longer measurements since the alignment must be maintained for a longer time.

### Exemplary Difficulty #2—Limited Lateral Spatial Resolution

Another difficulty with many current lightsheet microscopes is the limitation on the lateral spatial resolution that can be achieved by the detection microscope. Indeed, many current lightsheet microscopes use one or more conventional microscopes for the detection microscope. The lateral spatial resolution of a conventional microscope is limited in a known way. This is a limit to image quality.

Thus, there is a need in the art for improved lightsheet microscopes that may address, for example, one or more of the above-noted difficulties or additional difficulties.

### SUMMARY OF THE INVENTION

In one of its aspects the present invention provides a RSI lightsheet microscope that combines lightsheet illumination and rotational-shear interferometry.

As used herein, “2-D” stands for two-dimensional; “3-D” stands for three-dimensional; “MTF” Stands for modulation transfer function; and, “RSI” stands for rotational-shear interferometer.

### Definitions

As used herein the following terms have the following meanings.

The term “conventional imager” refers to an imager that forms a direct image on a detector. The term “conventional microscope” refers to a microscope that forms a direct image on a detector. An RSI imager is not a conventional imager since the data recorded by the detector needs to be processed to infer an image. Likewise, an RSI microscope is not a conventional microscope.

The term “lightsheet microscope” refers to a system that includes both lightsheet illumination and a detection microscope. The terms “conventional microscope” and “RSI microscope” each refer only to the detection microscope, not the lightsheet illumination system.

The “region-of-focus” of an imaging system refers to the 3-D region over which an object point will appear “in focus” in the 2-D image. In FIGS. 1, 2, 3, 5, 6, 9A, 9B, 9C, and 9D, a pair of dashed lines marks the boundaries of the “region-of-focus” of the detection microscope. For example, in FIG. 1 the region-of-focus is labeled 103. An object point located between the pair of dashed lines will appear in focus in the 2-D image. An object point located outside the region-of-focus will appear blurred in the 2-D image.

The “depth-of-field” of an imaging system refers to the distance over which the “region-of-focus” extends in the “z” direction. In FIGS. 1, 2, 3, 5, 6, 9A, 9B, 9C, and 9D the “depth-of-field” is the distance between the two dashed lines in the “z” direction.

The “plane-of-mid-focus” refers to the plane within the region-of-focus halfway between the two ends of the region-of-focus in the “z” direction. For example, in FIG. 1 the “plane-of-mid-focus” is halfway between the two dashed lines that mark region-of-focus 103.

In a system with “field curvature” aberration, the mid-focus surface may be curved rather than planar. For simplicity of discussion, systems discussed here are approximated to have no “field curvature.” The same concepts apply when “field curvature” is present.

“Tilt-offset” refers to the angle between (1) the plane of the lightsheet and (2) the plane-of-mid-focus of the detection microscope. This is illustrated in FIG. 2. For example, in FIG. 2 the “tilt-offset” is labeled 204 and has a value of 22 degrees. This value was chosen for clarity and ease of illustration. In FIGS. 1, 3, 5, 9A, 9B, 9C, and 9D the “tilt-offset” is zero.

“Tilt-alignment” refers to the alignment that minimizes the “tilt-offset.” The “tilt-alignment” can involve adjustment of (1) the tilt angle of the lightsheet, (2) the tilt angle of the region-of-focus of the detection microscope, or (3) a combination of (1) and (2).

“z-offset” refers to the distance in the “z” direction between (1) the plane of the lightsheet (the plane through the center of the lightsheet) and (2) the plane-of-mid-focus of the detection microscope after correcting for “tilt-offset.” This is illustrated in FIG. 3. In FIG. 1 and FIG. 2 the “z-offset” is zero. In FIG. 3 the “z-offset” is non-zero.

“z-alignment” refers to the alignment that minimizes the “z-offset.” The “z-alignment” can involve adjustment of (1) the location of the lightsheet, (2) the location of the region-of-focus of the detection microscope, or (3) a combination of (1) and (2).

### BRIEF DESCRIPTION OF THE DRAWINGS

The foregoing summary and the following detailed description of exemplary embodiments of the present invention may be further understood when read in conjunction with the appended drawings, in which:

FIG. 1 schematically illustrates the concept of lightsheet microscopy;

FIG. 2 schematically illustrates the meaning of the terms tilt-offset and tilt-alignment;

FIG. 3 schematically illustrates the meaning of the terms z-offset and z-alignment;

FIG. 4 schematically illustrates a lightsheet microscope with a rotational-shear interferometer in accordance with the present invention;

FIG. 5 schematically illustrates why the z-alignment is easier to perform when the depth-of-field of the detection microscope is large;

FIG. 6 schematically illustrates why the tilt-alignment is easier to perform when the depth-of-field of the detection microscope is large;

FIG. 7 schematically illustrates the light path in one embodiment of a rotational-shear interferometer;

FIG. 8 schematically illustrates one method of operation;

FIGS. 9A, 9B, 9C, and 9D further schematically illustrate a method of operation; and

FIG. 10 schematically illustrates an alternate embodiment involving a lightsheet microscope with two rotational-shear interferometers in accordance with the present invention.

### DETAILED DESCRIPTION

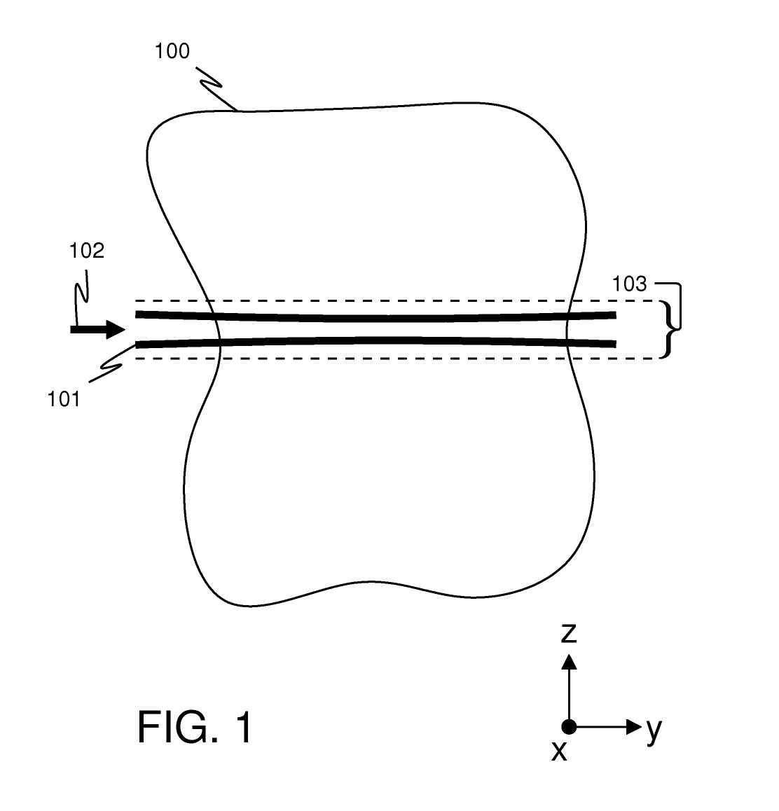

Turning now to the figures, FIG. 1 schematically illustrates the concept of lightsheet microscopy. FIG. 1 illustrates part of a lightsheet microscope representing a snapshot at one scan step of a sample 100 under study. Sample 100 could be a biological specimen, for example. Sample 100 is three-dimensional and extends in the “+/−x”, “+/−y”, and “+/−z” directions. (Mutually orthogonal coordinate axes indicate the “x”, “y”, and “z” directions, with each arrow on each coordinate axis pointing in the positive direction along the axis. For example, the “+y” direction is to the right on the page.) For simplicity of illustration, only a two-dimensional slice of sample 100 is drawn.

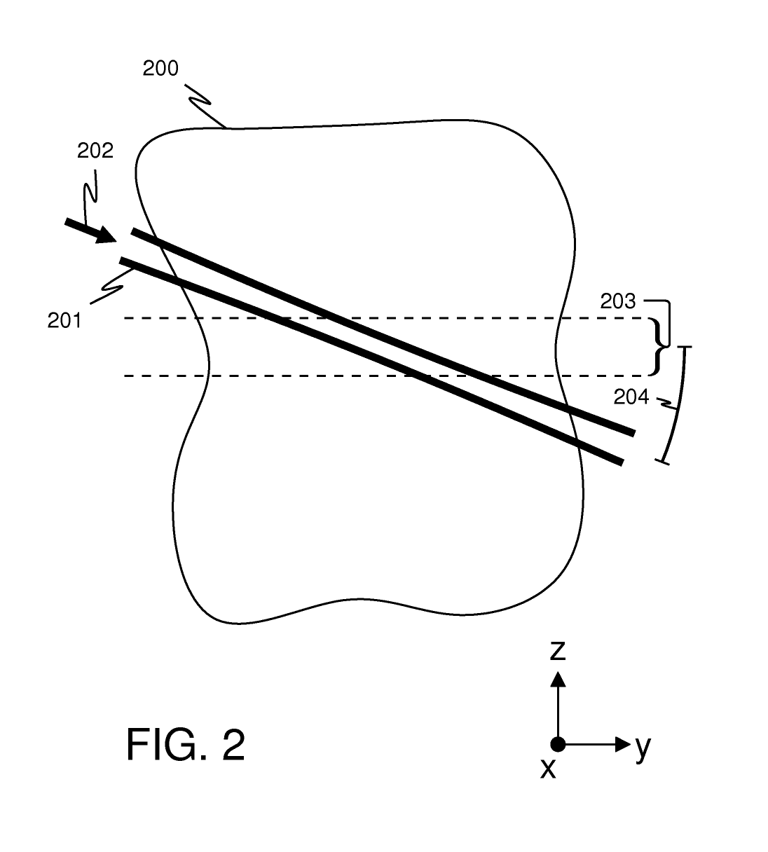

Lightsheet 101 enters sample 100 in the direction indicated by arrow 102 and represented by a pair of thick lines. The lightsheet 101 is parallel to the x-y plane and has a slight curvature, customary of the behavior of a Gaussian beam. A Gaussian beam is one form of illumination used to generate a lightsheet. The most-narrow part of lightsheet 101 is located near the center of sample 100. Lightsheet 101 expands slightly in the “+/−z” direction as there is an increase in the distance from the most-narrow part of lightsheet 101. This comports with the behavior of a Gaussian beam. The detection microscope is not shown in FIG. 1. Light from sample 100 travels in the “+z” direction to a detection microscope. A region-of-focus 103 is centered in the “z” direction on lightsheet 101. FIG. 1 is meant to be compared directly to FIGS. 2, 3, 5, and 6. These Figures are all drawn on the same scale, each of which includes a region-of-focus. The depth-of-field is the same in FIGS. 1-3.

FIG. 2 schematically illustrates the meaning of the terms tilt-offset and tilt-alignment. Like FIG. 1, FIG. 2 illustrates part of a lightsheet microscope representing a snapshot at one scan step of a sample 200 under study. Light from sample 200 travels in the “+z” direction to the detection microscope. The detection microscope is not shown. The region-of-focus is labeled 203. A difference between FIG. 2 and FIG. 1 is that in FIG. 2 the lightsheet 201 is tilted. The lightsheet 201 is tilted about the “x” axis, and arrow 202 indicates the direction the lightsheet 201 enters sample 200.

In FIG. 2 there is a sufficiently-large tilt-offset 204 between lightsheet 201 and region-of-focus 203 as to produce blur in the recorded image. Parts of the illuminated region of sample 200 are outside region-of-focus 203. Light from points outside the region-of-focus of the detection microscope contributes to blur in the recorded image. To avoid blur in the recorded image, only a small tilt-offset 204 is allowed. The region of the sample illuminated by the lightsheet 201 (within the field-of-view of interest) should fit completely within the region-of-focus of the detection microscope. This alignment requirement is the tilt-alignment. The system illustrated in FIG. 2 does not have proper tilt-alignment, because the tilt-offset 204 is too large.

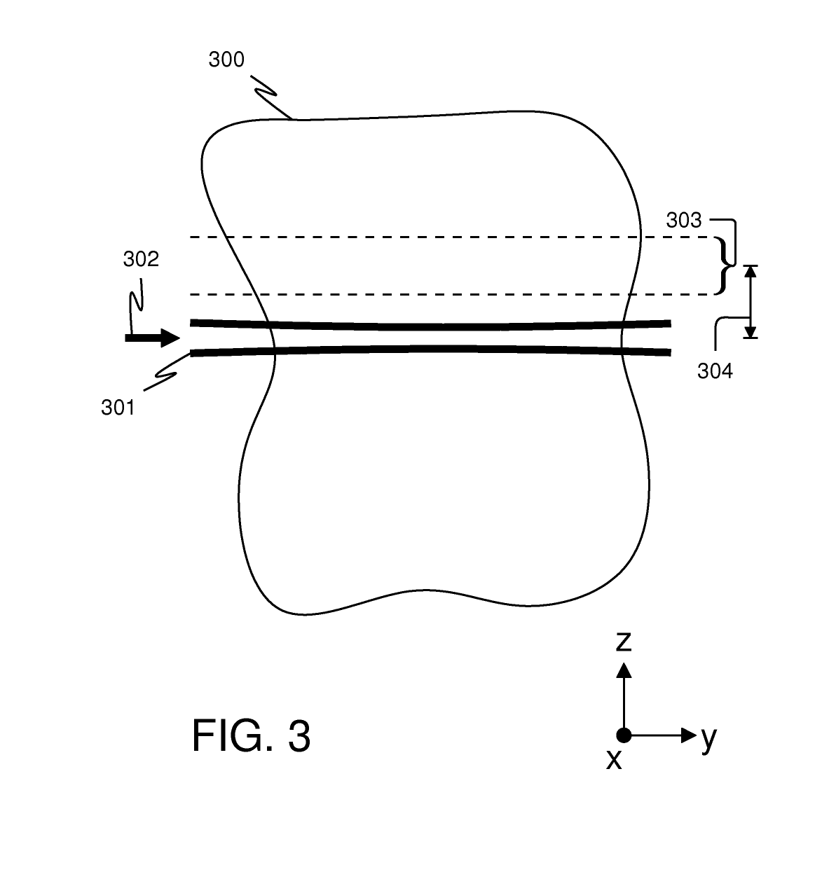

FIG. 3 schematically illustrates the meaning of the terms z-offset and z-alignment. Like FIGS. 1 and 2, FIG. 3 illustrates part of a lightsheet microscope representing a snapshot at one scan step of a sample 300 under study. Light from sample 300 travels in the “+z” direction to the detection microscope. The detection microscope is not shown. The region-of-focus is labeled 303. A difference between FIG. 3 and FIG. 1 is that in FIG. 3 the region-of-focus is offset in the “z” direction from lightsheet 301. Arrow 302 indicates the direction the lightsheet 301 enters sample 300. In FIG. 3 there is a sufficiently-large z-offset 304 between lightsheet 301 and region-of-focus 303 as to produce blur in the recorded image. The illuminated region of sample 300 is outside region-of-focus 303. Light from points outside the region-of-focus 303 of the detection microscope produces blur in the recorded image.

To avoid blur in the recorded image, only a small z-offset 304 is allowed. The region of the sample 300 illuminated by the lightsheet 301 (within the field-of-view of interest) should fit completely within the region-of-focus 303 of the detection microscope. This alignment requirement is the z-alignment. The system illustrated in FIG. 3 does not have proper z-alignment, because the z-offset 304 is too large.

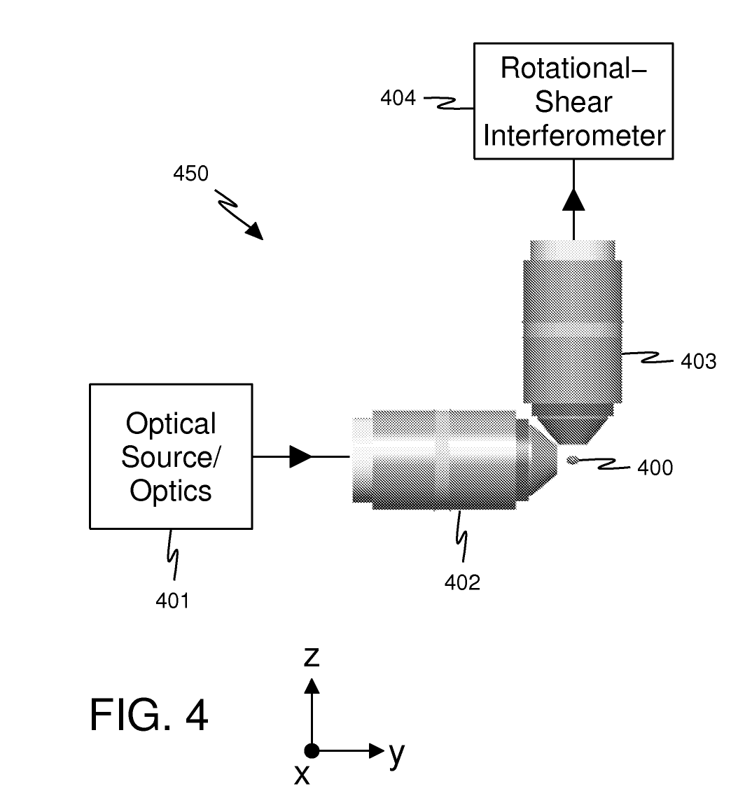

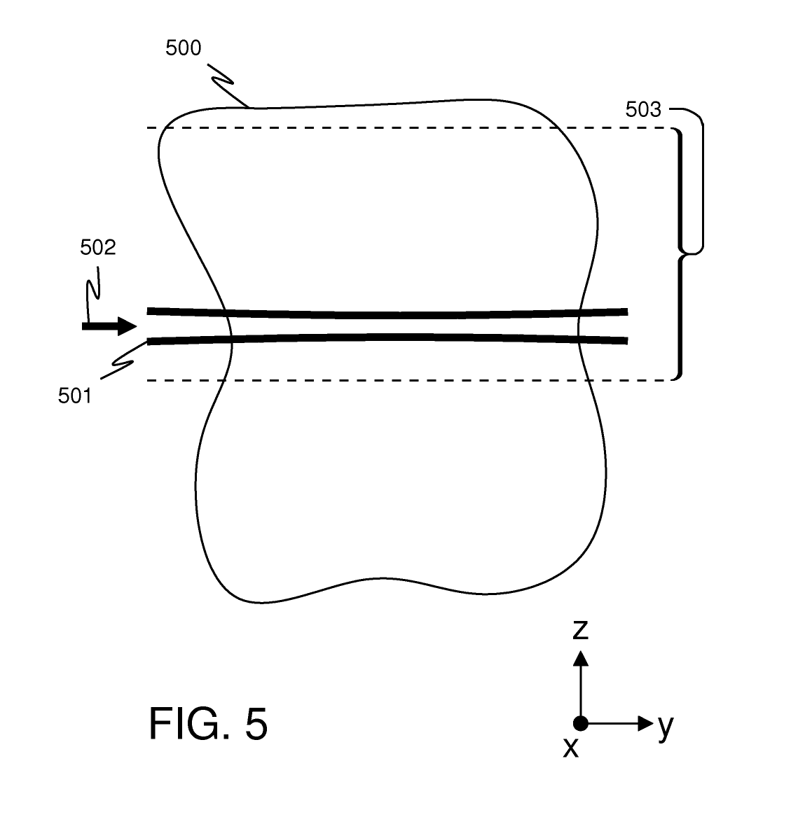

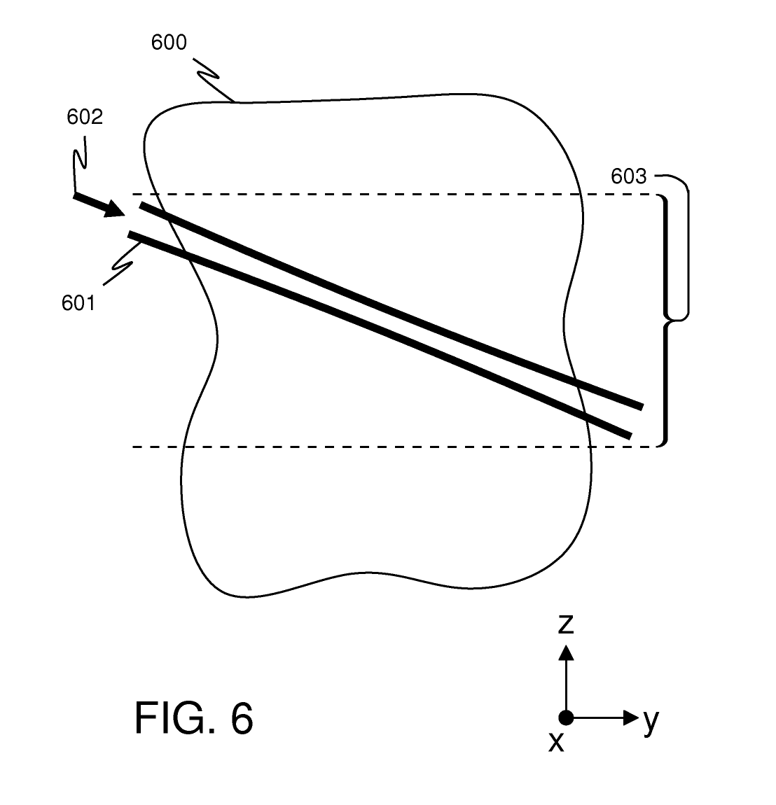

FIG. 4 schematically illustrates a RSI (rotational shear interferometer) lightsheet microscope 450 in accordance with the present invention. The RSI lightsheet microscope 450 includes an optical source/optics 401 that, in cooperation with an objective 402, generates a lightsheet used to illuminate a sample 400. Specifically, the objective 402, which may be a conventional microscope objective, is disposed between the optical source/optics 401 and sample 400 to create and deliver the lightsheet to the sample 400. Light from sample 400 is collected by a collection objective 403, which may also be a conventional microscope objective, and is delivered to an RSI 404. The objectives 402, 403 do not need be conventional microscope objectives; other suitable optical elements for creating the lightsheet and collecting light from the sample 400, respectively, may be used. As seen in FIGS. 5 and 6, the RSI lightsheet microscope 450 provides enhanced performance with regard to z-alignment and tilt-alignment, due, in part to the increased depth-of-field of the RSI 404. In particular, FIG. 5 schematically illustrates why the z-alignment is easier to perform when the depth-of-field of the detection microscope is large.

### Operation

There are several manners in which the embodiment 450 can be operated. Some examples are as follows. This list is not meant to be limiting.

### Exemplary Manner of Operation #1

The lightsheet and the RSI microscope are both held fixed with no adjustment. The sample is translated (and possibly rotated) in steps through the lightsheet. At each step the RSI records a snapshot. This process is repeated until the entire sample has been imaged.

### Exemplary Manner of Operation #2

In this scenario the depth-of-field of the RSI microscope is large enough to encompass the entire sample. The system is set up so the sample is completely contained within the depth-of-field. The lightsheet is scanned through the entire sample. At each scan step the RSI microscope records a snapshot. No intermediate refocusing of the RSI microscope is required.

### Exemplary Manner of Operation #3

In this scenario, the depth-of-field of the RSI microscope is not large enough to encompass the entire sample. The sample is held fixed in location and orientation throughout the measurement. The lightsheet is scanned through the sample in steps. The RSI microscope must be refocused one or more times as the lightsheet is scanned.

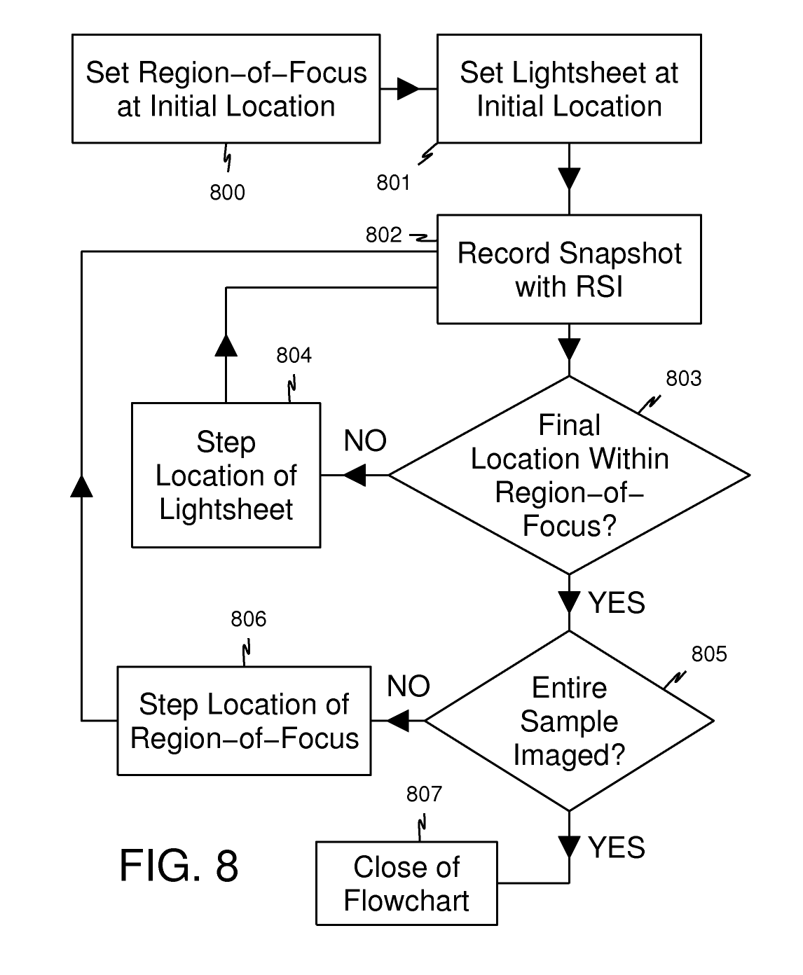

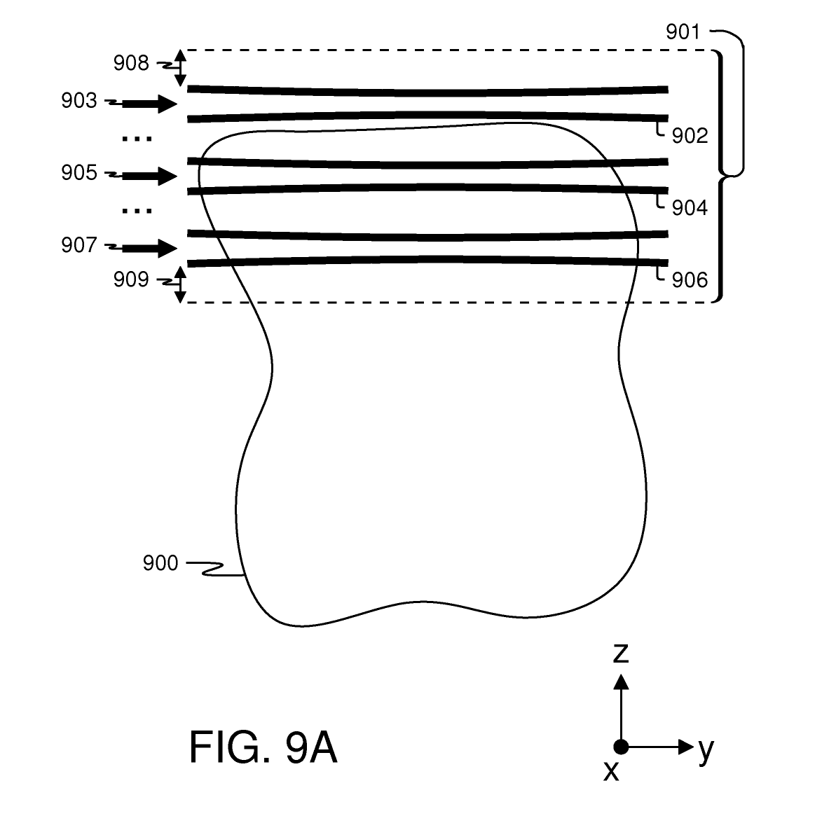

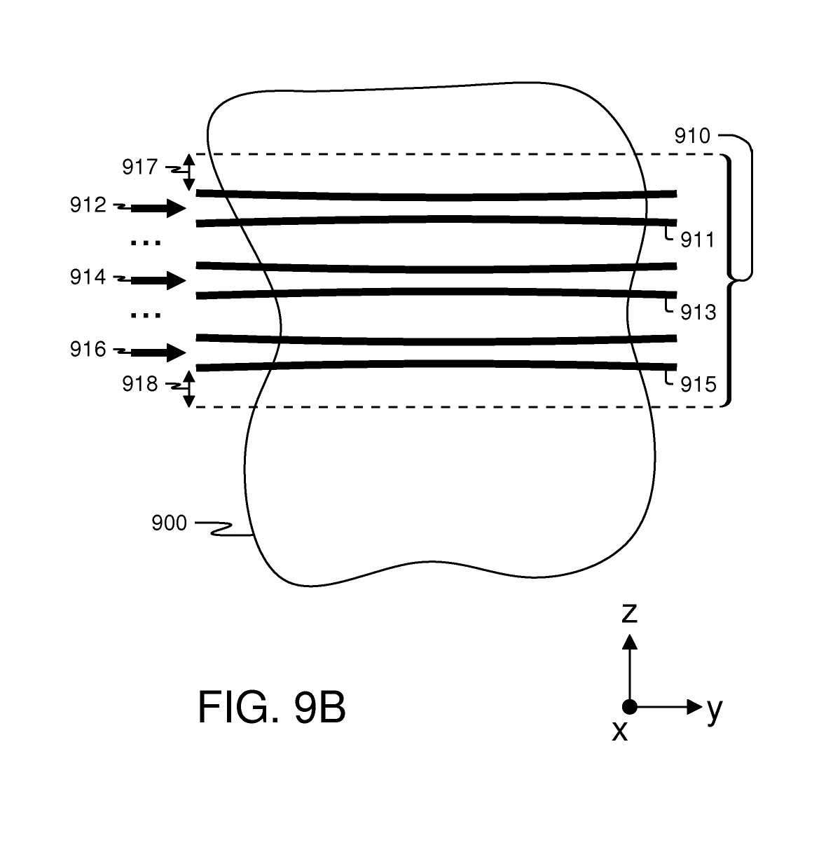

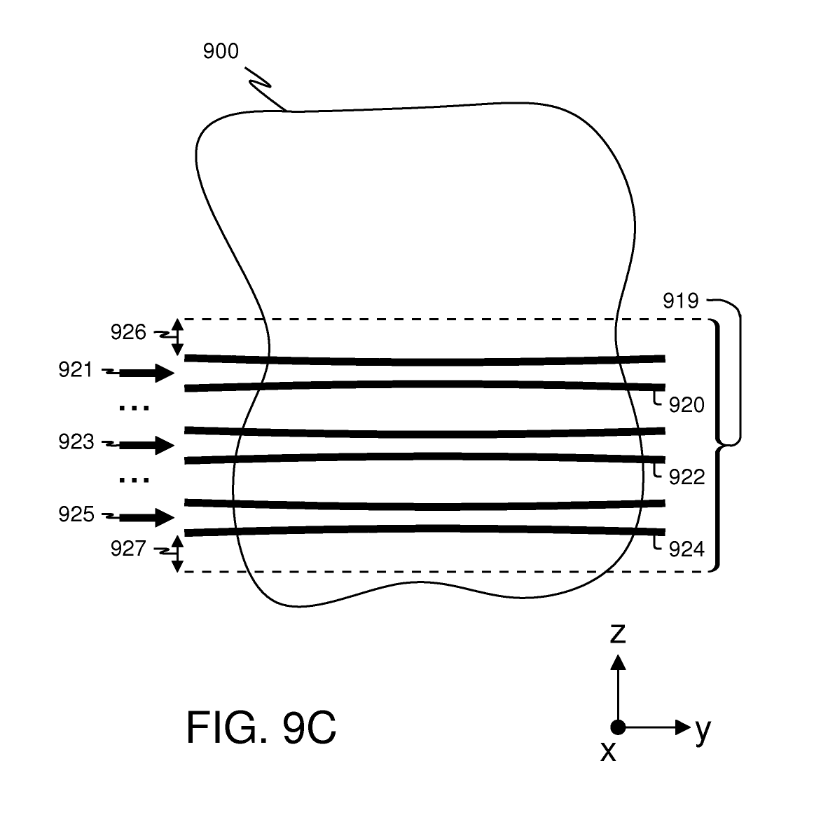

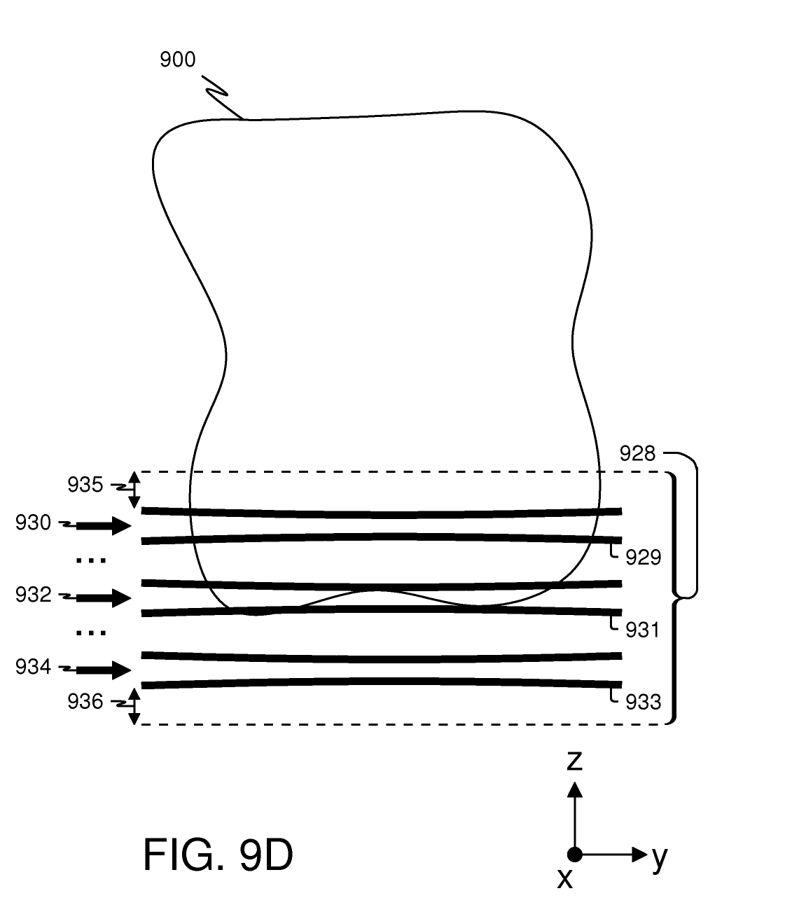

A flowchart is drawn in FIG. 8. The steps outlined in the flowchart are further illustrated in FIGS. 9A, 9B, 9C, and 9D.

The first step is step 800. The RSI focus is adjusted so the region-of-focus is near one end of the sample under study. This is further illustrated in FIG. 9A. Sample 900 is the sample under study. Region-of-focus 901 has been located near one end of sample 900.

The next step is step 801. The lightsheet is placed at its initial location within the sample. This corresponds to lightsheet 902. Arrow 903 illustrates the direction lightsheet 902 enters sample 900. Lightsheet 902 is not right at the edge of region-of-focus 901. Instead lightsheet 902 is separated from the edge of region-of-focus 901 by a distance labeled 908. There is a tradeoff a user makes in choosing a value for distance 908. A small value for distance 908 means more of the sample can be scanned before the RSI microscope must be refocused. A large value for distance 908 eases the z-alignment and tilt-alignment of the system.

The next step is step 802. The RSI microscope records a snapshot of the light from the sample.

The next step is step 803. Step 803 is a yes/no branch. If the lightsheet has been scanned through the intended area of the region-of-focus, the “yes” branch is followed and step 805 is next. Otherwise the “no” branch is followed and step 804 is next.

Lightsheet 902 is not at the end of the intended area of region-of-focus 901, so the “no” branch is followed to step 804. In step 804 the lightsheet location is stepped. Then as indicated with the arrow, the next step is 802, where a snapshot is again recorded with the RSI. This loop is repeated until the lightsheet location is at the end of the intended area of illumination of region-of-focus 901. Lightsheet 906 indicates the last intended location for the lightsheet. Lightsheet 906 is a distance 909 from the edge of region-of-focus 901. This is a buffer. The tradeoff is the same as was discussed in connection with buffer 908.

The lightsheet is stepped through a number of locations from location 902 to location 906. Location 904 is in the middle. Ellipses indicate that additional steps are taken between the lightsheet locations that are drawn. Location 904 is an intermediate location for the lightsheet during the scan. Arrow 903 shows the direction lightsheet 902 enters sample 900. Arrow 905 shows the direction lightsheet 904 enters sample 900. Arrow 907 shows the direction lightsheet 906 enters sample 900.

When the lightsheet is at location 906 and step 803 is reached, the “yes” branch is followed to step 805.

Step 805 is another yes/no branch. If the entire sample has been imaged then the “yes” branch is followed to step 807, which is the close of the flowchart. Otherwise the “no” branch is followed to step 806.

In step 806 the location of the RSI region-of-focus is stepped. Compare FIG. 9A to FIGS. 9B, 9C, and 9D. In going from one of these Figures to the next, the lightsheet region-of-focus is stepped through the sample. This involves moving from step 806 to step 802 as indicated in FIG. 8, and repeating the loop until the “no” branch is followed from step 805 to step 807.

At each location of the lightsheet region of focus, the lightsheet is scanned through as before in connection with FIG. 9A.

In FIG. 9B lightsheets 911, 913, and 915 travel in the directions indicated by arrows 912, 914, and 916 respectively. Markers 917 and 918 indicate the length of each buffer region. The region-of-focus is labeled 910. The sample is again labeled 900.

In FIG. 9C lightsheets 920, 922, and 924 travel in the directions indicated by arrows 921, 923, and 925 respectively. Markers 926 and 927 indicate the length of each buffer region. The region-of-focus is labeled 919. The sample is again labeled 900.

In FIG. 9D lightsheets 929, 931, and 933 travel in the directions indicated by arrows 930, 932, and 934 respectively. Markers 935 and 936 indicate the length of each buffer region. The region-of-focus is labeled 928. The sample is again labeled 900.

As indicated by the flowchart in FIG. 8, the last location of the lightsheet within one region-of-focus is the same as the first location of the lightsheet within the next region-of-focus. This provides data that assists with co-registration of the 2-D images recorded from different regions-of-focus.

FIG. 5 schematically illustrates the z-alignment performance of the RSI lightsheet microscope 450 by showing a snapshot at one scan step of a sample 500 under study. Here a lightsheet 501 illuminates sample 500, and arrow 502 indicates the direction lightsheet 501 enters sample 500, with light from sample 500 traveling in the +z direction to the detection microscope, i.e., the RSI 404 and collection objective 403. The magnitude of the z-offset in FIG. 5 is the same as magnitude of z-offset 304 in FIG. 3. A difference between FIG. 5 and FIG. 3 is that in FIG. 5 the detection microscope has a larger depth-of-field. The depth-of-field for region-of-focus 503 in FIG. 5 is larger (by a factor of approximately four) than the depth-of-field for region-of-focus 303 in FIG. 3. FIG. 5 and FIG. 3 are drawn on the same scale as each other. The factor-of-four difference is only an example used for illustrative purposes. Other values are possible.

In FIG. 5 the system is in focus even though the z-offset is not zero. The system has proper z-alignment. By comparison, the system in FIG. 3 is not in focus even though the z-offset is the same in FIGS. 3 and 5. The large depth-of-field in FIG. 5 is what allows the system to be in z-alignment despite the non-zero z-offset. In FIG. 5 a larger z-offset would be needed to place the system out of alignment. This illustrates why the z-alignment is easier to perform when the depth-of-field of the detection microscope is large.

FIG. 6 schematically illustrates the tilt-alignment performance of the RSI lightsheet microscope 450 by showing a snapshot at one scan step of the sample 600 under study. In particular, FIG. 6 illustrates why the tilt-alignment is easier to perform when the depth-of-field of the detection microscope is large. A lightsheet 601 illuminates sample 600, and arrow 602 indicates the direction lightsheet 601 enters sample 600, with light from sample 600 traveling in the +z direction to the detection microscope. The magnitude of the tilt-offset in FIG. 6 is the same as the magnitude of the tilt-offset 204 in FIG. 2. A difference between FIG. 6 and FIG. 2 is that in FIG. 6 the detection microscope has a larger depth-of-field. The depth-of-field for region-of-focus 603 in FIG. 6 is larger (by a factor of approximately four) than the depth-of-field for region-of-focus 603 in FIG. 2. FIG. 6 and FIG. 2 are drawn on the same scale as each other. The factor-of-four difference is only an example used for illustrative purposes. Other values are possible.

In FIG. 6 the system is in focus even though the tilt-offset is not zero. The system has proper tilt-alignment. By comparison the system in FIG. 2 is not in focus even though the tilt-offset is the same in FIGS. 2 and 6. The large depth-of-field in FIG. 6 is what allows the system to be in tilt-alignment despite the non-zero tilt-offset. In FIG. 6 a larger tilt-offset would be needed to place the system out of alignment. This illustrates why the tilt-alignment is easier to perform when the depth-of-field of the detection microscope detection microscope is large. Thus, FIGS. 5 and 6 illustrate the effects of having a relatively larger depth-of-field provided by the RSI 404 as contrasted with the relatively smaller depth-of-field illustrated in FIGS. 1-3 associated with a conventional microscope, such as exists on many current lightsheet microscopes. That is, the depth-of-field illustrated in FIG. 1-3 is the depth-of-field of a conventional microscope, whereas the depth-of-field illustrated in FIGS. 5 and 6 is the depth-of-field of an RSI microscope 450 in accordance with the present invention.

### Rotational-Shear Interferometer

Turning now to the rotational-shear interferometer 404 more specifically, the RSI 404 is an instrument in which light entering through an aperture is split into two beams. The two beams are recombined so as to produce interference fringes. The fringes can be analyzed to infer an image of the scene in front of the RSI 404. (As used herein, when an RSI is used in this manner, it is referred to as an RSI imager, and when an RSI is used more-specifically in a microscope configuration, it is referred to as an RSI microscope.) The angle of rotational-shear can be set to different values, depending on the application. When the angle of rotational-shear is 180 degrees, there term “180-degree RSI imager” is used herein.

The imaging performance of an RSI microscope may compared to the imaging performance of a conventional microscope in the cases where the following two conditions are met. (1) The entrance pupil of each microscope is the same distance from the object being imaged. (2) The sizes of the entrance pupils of the two microscopes are the same as each other. Under these two conditions, the following two comparisons can be made.

### (a) Long Depth-of-Field

The depth-of-field of the RSI microscope is long compared to the depth-of-field of the conventional microscope.

The reason the RSI microscope has a long depth-of-field is as follows. Consider an object point located front of the RSI microscope. The object is on the axis of the RSI microscope. Light from the object point generates two wavefronts incident on the RSI detector. Now move the object point along the axis of the RSI microscope to a new location a short distance away. There is a change in the curvature of the two wavefronts incident on the RSI detector. The magnitude of the change-in-curvature is the same for both wavefronts. The change-in-curvature is common-mode. Interferometers are generally insensitive to common-mode changes. The fringe pattern recorded by the RSI detector does not change much with the movement of the object point along the imager's axis. For this reason, the RSI microscope has a long depth-of-field.

### (b) Superior Lateral Spatial Resolution

Under the scenario where spatially-incoherent light is used to image the scene, a 180-degree RSI imager is characterized by a modulation transfer function (MTF) superior to that of a conventional imager. The MTF is superior by up to a factor of two, as measured by the area under the MTF curve. The MTF is a measure of the lateral spatial resolution of the imaging system.

The image generated by an RSI imager is a conical projection of the 3-D scene in front of the RSI. The vertex of the cone is the center of the RSI imager's entrance pupil.

### RSI Layout

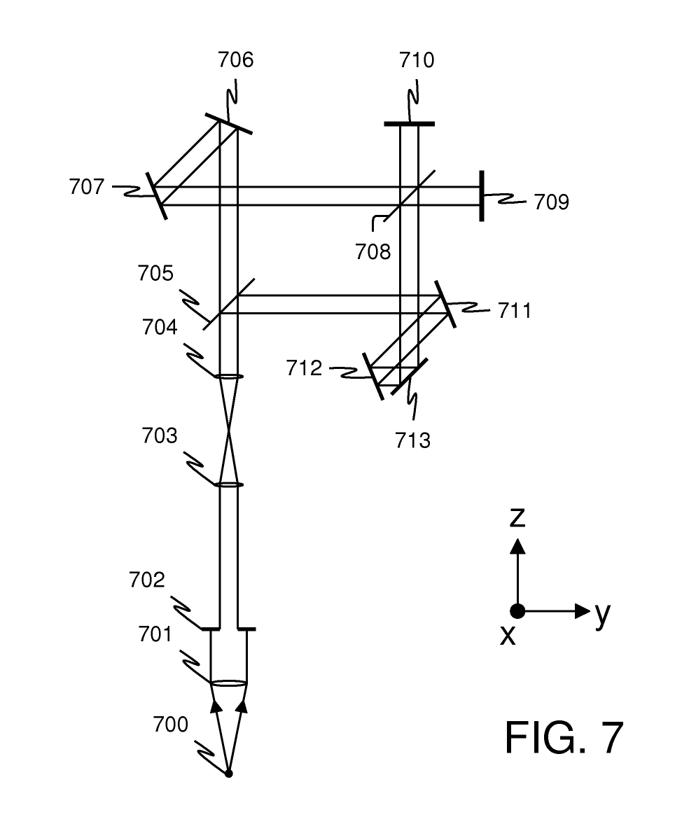

FIG. 7 illustrates a layout for a simple version of an RSI microscope, including an object point from the sample under study, and including a model for the objective lens. The system illustrated in FIG. 7 is drawn as 2-dimensional. Most current RSIs are 3-dimensional. FIG. 7 is limited to 2 dimensions for simplicity of illustration. The figure provides the information needed without the complication of 3-dimensional drawings.

The lenses illustrated in FIG. 7 are illustrated as “thin lenses,” as is common in the field of optics.

Object point 700 emits light towards the objective, such as objective 403. In the thin-lens model illustrated in FIG. 7, the objective (which typically has many optical surfaces internally) is represented by a single thin lens 701. Lens 701 collimates the light. The light travels to aperture 702, commonly referred to in the field of optics as the “system stop.” Aperture 702 truncates the beam. The beam propagates to thin-lenses 703 and 704. Optics 703 and 704 work together to image aperture 702 to detectors 709 and 710. After leaving lens 704 the light propagates to beamsplitter 705. One beam travels to fold mirrors 706 and 707, then to beamsplitter 708. The other beam travels to fold mirrors 711, 712, and 713, then to beamsplitter 708. Two beams are incident on each detector 709 and 710. The two beams respond in a counter-tilt fashion to movement of object point 700 within the “x-y” plane. The counter-tilt is due to the fact that one beam experiences an odd number of reflections while the other beam experiences an even number of reflections.

As illustrated in FIG. 7, an object point at location 700 generates wavefronts on detectors 709 and 710 that are flat. When the object point is moved to a different location along the z-axis, the wavefronts incident on detectors 709 and 710 are no longer flat. I refer to the RSI as being at “best focus” when the wavefronts incident on detectors 709 and 710 are flat. There are various ways to adjust the RSI focus. One way is to adjust the locations of lenses 703 and 704, possibly including the separation between the two lenses, in the “+/−z” direction.

### Advantages

As demonstrated above, the RSI lightsheet microscope 450 provides multiple advantages. For example, compared to many current lightsheet microscopes, the tilt-alignment and the z-alignment are less exacting. This mitigates one or more of the negative impacts listed above under Difficulty #1. The reason the tilt-alignment and the z-alignment are less exacting is as follows. The depth-of-field of the detection microscope of the exemplary RSI lightsheet microscope 450 is larger than the depth-of-field of the detection microscope in many current lightsheet microscopes. A larger depth-of-field makes it easier to perform the tilt-alignment and z-alignment. In addition, compared to the detection microscope in many current lightsheet microscopes (a conventional microscope), the lateral spatial resolution of the detection microscope of the exemplary RSI lightsheet microscope 450 is superior (as measured by the area under the MTF curve) when using spatially-incoherent light, which mitigates Difficulty #2 noted above.

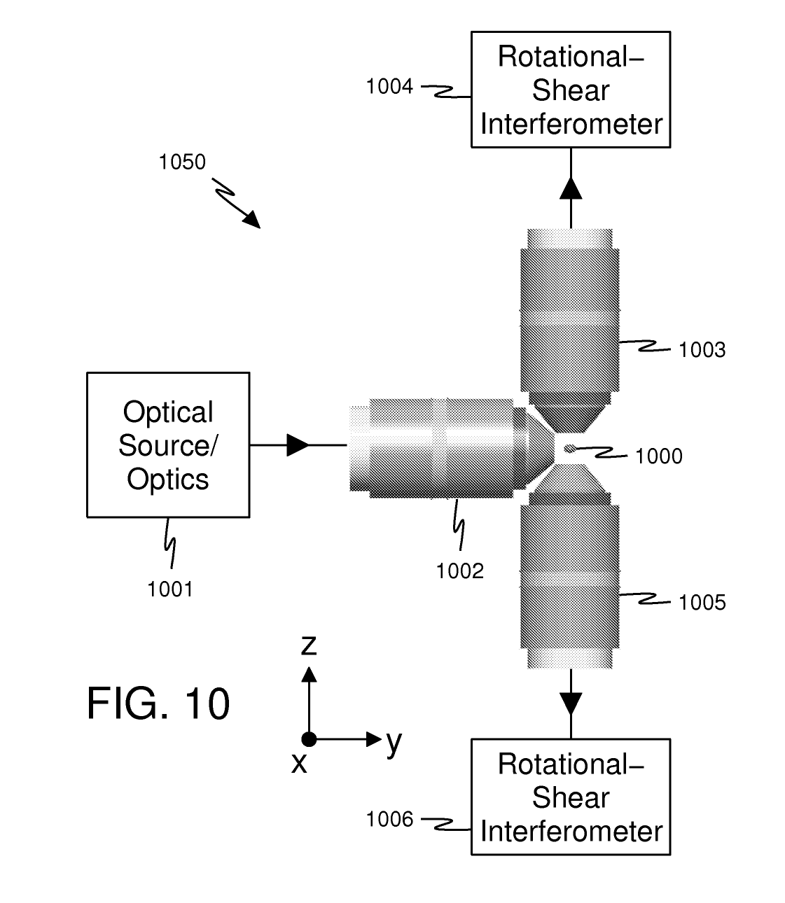

In addition to the particular exemplary RSI lightsheet microscope 450 disclosed above, further variations are included within the scope of the present invention. For example, the lightsheet microscope 450 may include more than one lightsheet source, such as counter-propagating, co-planar lightsheet illumination of a sample as disclosed for example in U.S. patent application publication 2011/0115895. In addition, the RSI lightsheet microscope 450 can use more than one detection microscope. For example, a second detection microscope may view the sample from a perspective 180 degrees away from the first detection microscope. This is illustrated in FIG. 10. Sample 1000 is illuminated by the lightsheet generated by 1001 and 1002 working in concert. Objective 1003 presents light from the sample to RSI 1004. Objective 1005 presents light from the sample to RSI 1006. Reference 1050 refers to the entire system. More than two detection microscopes may also be used. Furthermore, a microscope objective may be used for both transmission of light to the sample and receipt of light from the sample.

Still further, adaptive optics may be incorporated into RSI lightsheet microscopes in accordance with the present invention. One use of adaptive optics is to compensate for the otherwise-detrimental light-scattering properties of the sample. Additionally, the RSI 404 may be constructed and used in a number of configurations, such as a Michelson or Mach-Zehnder configuration.

Moreover, the rotational-shear angle of the RSI can be set to different values. There are different ways to set the rotational-shear angle to a given value. For example consider the case of a 180-degree rotational-shear angle. This corresponds to a counter-tilt of the two beams incident on the RSI detector. One way to produce a counter-tilt is to use an odd number of reflections in one arm of the interferometer and an even number of reflections in the other arm. A different way to produce a counter-tilt is to send the light in one arm of the interferometer through an intermediate focus within the arm.

One can also adjust the angle at which the two beams are incident on the detector. For a point at the center of the field-of-view, the two resulting beams can be incident on the detector at normal incidence or at some different angle (e.g., +/−3 degrees). If the two beams are incident at normal incidence, there will be ambiguity (the twin image problem). If the angle-of-incidence of each beam corresponding to the center of the field-of-view is large enough, the twin image problem is avoided.

Still further, the RSI may be used in a modified form known as a quadrature-phase interferometer.

The RSI 404 may also use fringe-scanning to obtain a time series of exposures with different phase differences between the two arms of the interferometer. The RSI 404 may be configured to compensate or correct for differences in the polarization response of the two arms of the interferometer, for example by the addition of phase plates. The RSI 404 may further be configured to achromatize the fringe pattern to increase the spectral bandwidth of the RSI 404. The RSI 404 may use mirrors that may or may not contain a roofline through the middle of the mirror, and may optionally include a prism to steer light.

Different types of beamsplitters may also be used within the RSI 404, such as cube or pellicle beam splitters, or even a glass plate that reflects off one of its external surfaces. There are also different ways to convert the fringe pattern recorded on the RSI detector into an image. One method is to Fourier-transform the fringe pattern, and a second method is to fit the fringe pattern with a set of orthogonal functions. In the case of a sparse image, a procedure exists to convert the fringe pattern recorded on the RSI detector into an image with spectral information for each point in the image.

Sometimes the lightsheet activates quantum dots rather than fluorophores. Sometimes it is scattered lightsheet-light from small particles like beads that is used for the imaging.

An RSI lightsheet microscope 450 in accordance with the present invention may be used in conjunction with a technique like Photo-Activated Localization Microscopy (PALM) or Stochastic Optical Reconstruction Microscopy (STORM). PALM and STORM are used for imaging on a spatial scale smaller than the wavelength of light. An RSI lightsheet microscope 450 used in accordance with the present invention may be configured for two-photon lightsheet microscopy.

Different techniques can be used to generate the lightsheet, such as a cylindrical lens or the rapid scanning of an axial beam. Different beams can be used in the lightsheet, such as Gaussian beams or Bessel beams.

There are other techniques for stepping the lightsheet through the sample (or the sample through the lightsheet). For example the stepping may skip regions of the sample known to be empty of interesting targets.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A method for lightsheet imaging of a sample, comprising:
providing a rotational-shear interferometer;
setting a region-of-focus of the rotational-shear interferometer at an initial location relative to the sample;
positioning a lightsheet at an initial location within the sample; and
recording light emitted from the sample.

2. The method according to claim 1, wherein the step of positioning the lightsheet comprises positioning the lightsheet within the region-of-focus.

3. The method according to claim 1, comprising moving the location of the lightsheet relative to the sample and then recording light emitted from the sample at the new location.

4. The method according to claim 3, where the step of moving the location of the lightsheet relative to the sample comprising moving the sample.

5. The method according to claim 3, where the step of moving the location of the lightsheet relative to the sample comprising moving the lightsheet.

6. The method according to any one of claims 1-5 or 9, comprising moving the location of the region-of-focus of the rotational-shear interferometer within the sample.

7. The method according to claim 6, wherein the step of moving the location of the region-of-focus comprises adjusting the rotational-shear interferometer focus.

8. An optical imaging system, comprising:
a source of optical radiation;
lightsheet optics in optical communication with the source of optical radiation, the optics configured to receive the optical radiation and configured to generate a lightsheet at a selected location within the optical imaging system;
collection optics in optical communication with the selected location; and
a rotational-shear interferometer in optical communication with the collection optics.

9. The method according to claim 2, comprising moving the location of the lightsheet relative to the sample and then recording light emitted from the sample at the new location.
